(19) United States
(12) Patent Application Publication
(10) Pub. No.: US 2010/0284125 A1
(43) Pub. Date: Nov. 11, 2010

(54) Nanowire capacitor and method of manufacturing the same

(75) Inventors: Won Ha MOON, Suwon (KR); Chang Hwan CHOI, Seongnam (KR); Chul Tack LIM, Suwon (KR); Young Nam HWANG, Suwon (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRO-MECHANICS CO., LTD., Suwon (KR)

(21) Appl. No.: 11/976,073

(22) Filed: Oct. 19, 2007

(30) Foreign Application Priority Data
Oct. 19, 2006 (KR) 10-2006-0101986

(51) Int. Cl. H01G 4/008; H01G 4/005; H01G 4/10; B05D 5/12

(52) U.S. Cl. 361/305; 361/303; 427/79; 977/762; 977/948

(57) ABSTRACT

Provided is a method of manufacturing a nanowire capacitor including forming a lower metal layer on a substrate; growing conductive nanowires on the lower metal layer, the conductive nanowires including metal and transparent electrodes; depositing a dielectric layer on the lower metal layer including the grown conductive nanowires; growing dielectric nanowires on the deposited dielectric layer; and depositing an upper metal layer on the dielectric layer including the grown dielectric nanowires.

### CROSS-REFERENCE TO RELATED APPLICATIONS

This application claims the benefit of Korean Patent Application No. 10-2006-0101986 filed with the Korea Intellectual Property Office on Oct. 19, 2006, the disclosure of which is incorporated herein by reference.

### BACKGROUND OF THE INVENTION

1. Field of the Invention

The present invention relates to a nanowire capacitor and a method of manufacturing the same, which can increase a charge capacity by using nanowires.

2. Description of the Related Art

In general, Multi-Layer Ceramic Capacitors (hereinafter, referred to as ‘MLCC’) are chip-type condensers mounted on printed circuit boards of various electronic products such as mobile communication terminals, notebooks, computers, Personal Digital Assistants (PDAs) and the like and serve to charge or discharge electricity. Depending on the use and capacity of the MLCCs, the MLCCs have various sizes and lamination types.

Such MLCCs have a structure shown in FIGS. 1A and 1B. FIG. 1A is a perspective view of an MLCC, and FIG. 1B is a cross-sectional view taken along line A-A of FIG. 1A.

As shown in FIG. 1B, the MLCC includes a dielectric ceramic layer 100, a plurality of internal electrodes 200 disposed in the dielectric ceramic layer 100, and an external electrode 300 exposed to either side of the dielectric ceramic layer 100 and connected to the internal electrodes 200.

The external electrode 300 can be formed using generally known methods such as a dipping method, a sputtering method, a paste baking method, a vapor deposition method, and a plating method. Among them, the dipping method is widely used for forming an external electrode. In the dipping method, an MLCC is attached to a jig, Cu paste is applied on a portion of the MLCC where the external electrode is to be formed, and the MLCC is heat-treated. Further, Ni and Sn—Pb are sequentially plated on the portion, thereby forming an external electrode.

Recently, in order to minimize a mounting cost and a mounting area, MLCCs are used as array-type MLCCs. However, the array-type MLCCs have poorer falling reliability than general MLCCs because of the mounting form. Therefore, to overcome such a defect, when an external electrode 300 of the array-type MLCC is formed, a copper layer is first formed, and a stress relaxation layer composed of Ag-epoxy or the like is then formed so as to prevent the damage of a product caused by a falling impact. Then, Ni and Sn are sequentially plated on the stress relaxation layer to thereby complete the forming of the external electrode 30.

Recently, the miniaturization and ultra-high capacity of the MLCC have been achieved through the reduction in thickness of an internal electrode and multilayered dielectric layer. To implement a multilayered dielectric layer according to the ultra-high capacity of the MLCC, dielectrics such as BaTiO₃, MgO, MnO₃, V₂O₅, Cr₂O₃, Y₂O₃, a rare earth element, glass frit and the like composing the dielectric layer should be miniaturized. To secure electric reliability by minimizing the effect of a high electric field caused when the thickness of the dielectric layer is reduced into less than 3 μm, slurry needs to be designed in consideration of dispersibility of particles. However, a sintering driving force increases due to an increase in surface area caused by the miniaturization of particles, and thus grains are rapidly grown.

In manufacturing an ultra-high-capacity MLCC, BaTiO₃ composing most of starting materials includes particles of which the sizes are 0.2, 0.15, and 0.1 μm. However, a considerably large quantity of particles are agglomerated in a synthesis process such as hydrothermal synthesis, oxalate, hydrolysis, and solid state synthesis and in a heat-treatment process for removing impurities and securing crystallinity.

Meanwhile, chips are manufactured as follows. BaTiO₃ power is mixed with a ceramic additive, an organic solvent, a plasticizer, a bonding agent, and a dispersing agent such that slurry is manufactured using a basket mill. Then, a series of processes such as molding, lamination, pressing and the like are performed to thereby complete the manufacturing of chips.

As described above, the conventional MLCC does not use a thin film but a grain-structure dielectric.

FIG. 2A is a graph showing a characteristic change between the particle size of BaTiO₃ and a lattice parameter, and FIG. 2B is a graph showing a characteristic change between the particle size of BaTiO₃ and a dielectric constant. As shown in FIGS. 2A and 2B, the conventional grain-structure MLCC has a size effect that, as a particle size decreases at the normal temperature, tetragonal ferroelectricity is changed into cubic ferroelectricity.

According to various existing documents, it is known that, although there is a difference in particle size depending on the synthesis method, a dielectric property rapidly decreases at a particle size of less than 100 nm. Therefore, the MLCC having a grain-structure dielectric has a limitation in reducing the thickness of a dielectric and the size of a capacitor.

Further, a thin-film capacitor also has a limitation in increasing capacitance because of a dielectric property of the thin-film structure and a limit of surface area.

To solve such problems, Japanese Unexamined Patent Application Publication Nos. 2005-129566 and 2003-168745 disclose a relating technology using a nano-structure, and Korea Patent laid-open No. 2004-0069492 and U.S. Pat. No. 7,057,881 disclose a relating technology.

Japanese Unexamined Patent Application Publication No. 2005-129566 disclose a capacitor having a structure that a carbon nanotube or carbon nanohorn serving as a dielectric comes in contact with one surface of at least one electrode. In the capacitor, a high-capacity characteristic is implemented using a carbon nanotube different from an existing material.

Japanese Unexamined Patent Application Publication No. 2003-168745 has disclosed a method including: patterning a catalyst on a substrate; forming a metal nanotube, a nanowire, and a nanobelt to form an electrode layer; forming a dielectric layer on the electrode layer; and forming another electrode on the dielectric layer. In this method, however, a catalyst metal must be used to perform the patterning of the catalyst. Therefore, the process becomes complicated.

### SUMMARY OF THE INVENTION

An advantage of the present invention is that it provides a nanowire capacitor and a method of manufacturing the same, which can increase a contact surface area with an electrode by using nanowires, thereby increasing capacitance.

Additional aspects and advantages of the present general inventive concept will be set forth in part in the description which follows and, in part, will be obvious from the description, or may be learned by practice of the general inventive concept.

According to an aspect of the invention, a method of manufacturing a nanowire capacitor comprises forming a lower metal layer on a substrate; growing conductive nanowires on the lower metal layer, the conductive nanowires including metal and transparent electrodes; depositing a dielectric layer on the lower metal layer including the grown conductive nanowires; growing dielectric nanowires on the deposited dielectric layer; and depositing an upper metal layer on the dielectric layer including the grown dielectric nanowires.

According to another aspect of the invention, a method of manufacturing a nanowire capacitor comprises preparing a conductive substrate; growing conductive nanowires on the conductive substrate, the conductive nanowires including metal and transparent electrodes; depositing a dielectric layer on the conductive substrate including the grown conductive nanowires; growing dielectric nanowires on the deposited dielectric layer; and depositing an upper metal layer on the dielectric layer including the grown dielectric nanowires.

According to a further aspect of the invention, a nanowire capacitor comprises a substrate having a lower metal layer formed thereon; conductive nanowires grown on the lower metal layer formed on the substrate; a dielectric layer deposited on the lower metal layer including the grown conductive nanowires; dielectric nanowires grown on the deposited dielectric layer; and an upper metal layer deposited on the dielectric layer including the grown dielectric nanowires.

According to a still further aspect of the invention, a nanowire capacitor comprises a conductive substrate; conductive nanowires grown on the conductive substrate; a dielectric layer deposited on the conductive substrate including the grown conductive nanowires; dielectric nanowires grown on the deposited dielectric layer; and an upper metal layer deposited on the dielectric layer including the grown dielectric nanowires.

Preferably, the conductive nanowires and the dielectric nanowires have a height of 5 to 1000 nm.

Preferably, the conductive nanowires are formed of any one of Fe, Co, Ni, Cu, Au, Ag, and Indium Tin Oxide (ITO). Further, the dielectric nanowires are formed of SiO₂, Si₃N₄, Al₂O₃, ZrO₂, HfO₂, Ta₂O₅, TiO₂, SrTiO₃, BST, BaTiO₃, Pb(Zr, Ti)O₃, (Pb, La)(Zr, Ti)O₃, (Pb, La)TiO₃, SrBi₂Ta₂O₉, (Bi, La)₄Ti₃O₁₂ or a combination of at least any one of the compounds.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1A is a perspective view of an MLCC;

FIG. 1B is a cross-sectional view taken along line A-A of FIG. 1A;

FIG. 2A is a graph showing a characteristic change between the particle size of BaTiO₃ and a lattice parameter;

FIG. 2B is a graph showing a characteristic change between the particle size of BaTiO₃ and a dielectric constant;

FIG. 3A is an exploded view of a nanowire capacitor according to the invention, showing main layers of the capacitor;

FIG. 3B is a cross-sectional view of the nanowire capacitor of FIG. 3A; and

FIGS. 4A to 4D are sectional views showing a process for explaining a method of manufacturing a nanowire capacitor according to an embodiment of the invention.

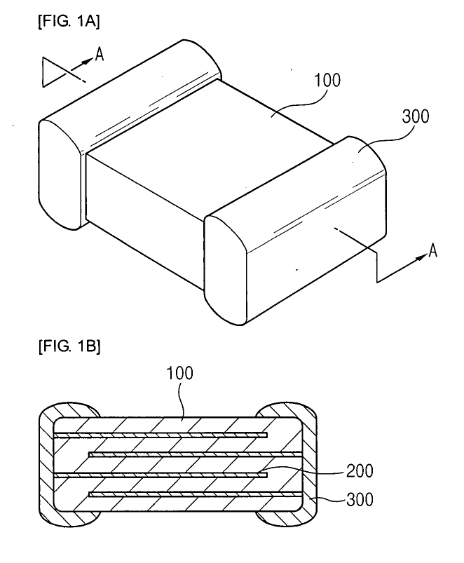

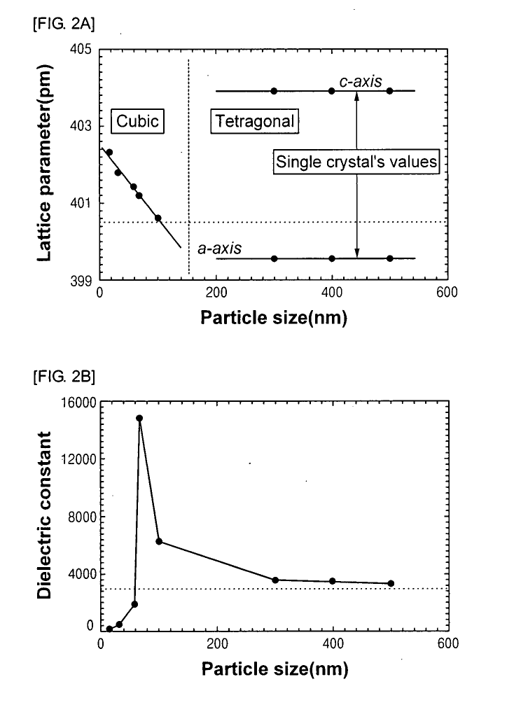

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept by referring to the figures. In the drawings, the thicknesses of layers and regions are exaggerated for clarity.

Hereinafter, preferred embodiments of the present invention will be described in detail with reference to the accompanying drawings.

Nanowire Capacitor

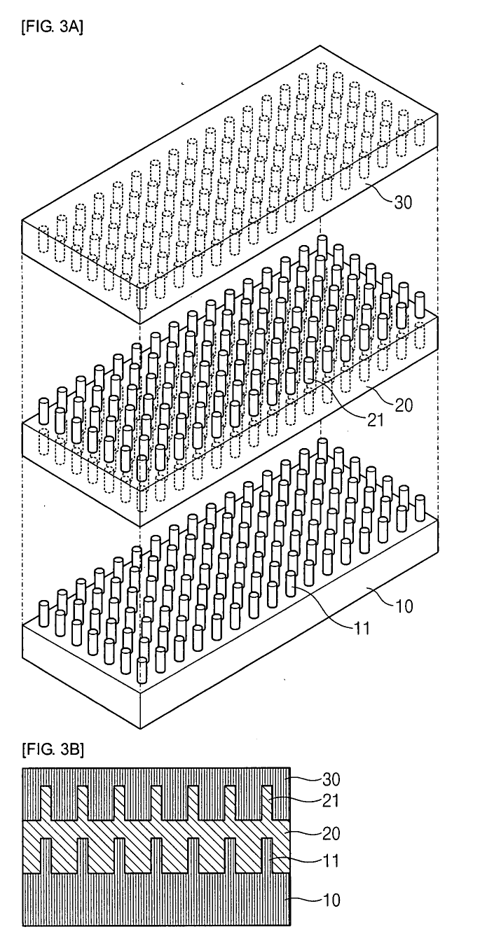

FIG. 3A is an exploded view of a nanowire capacitor according to the invention, showing main layers of the capacitor. FIG. 3B is a cross-sectional view of the nanowire capacitor of FIG. 3A.

The nanowire capacitor according to the invention includes a substrate 10 having a lower metal layer formed thereon, conductive nanowires 11 formed on the lower metal layer formed on the substrate 10, a dielectric layer 20 deposited on the lower metal layer including the grown nanowires 11, dielectric nanowires 21 grown on the deposited dielectric layer 20, and an upper metal layer 30 deposited on the dielectric layer 20 including the grown dielectric nanowires 21.

When the substrate 10 forming the lowermost layer of the capacitor is formed of a non-conductive material, the lower metal layer may be formed on the substrate 10 by coating or the like.

Otherwise, when the substrate 10 is formed of a conductive material, the lower metal layer may be omitted.

That is, the conductive substrate 10 or the lower metal layer serves as a positive or negative lower electrode 10.

On the conductive substrate 10 or the lower metal layer, the conductive nanowires 11 are grown and formed.

The conductive nanowires 11 are formed of a metallic material such as Fe, Co, Ni, Cu, Au, Ag or the like or a transparent electrode material such as Indium Tin Oxide (ITO) or the like. Preferably, the nanowires 11 have a height of 5 to 1000 nm.

Further, the conductive nanowires 11 may be grown randomly on the conductive substrate 10 or the lower metal layer. Alternately, the conductive nanowires 11 may be grown on the conductive substrate or the lower metal layer by using a catalyst, in accordance with a predetermined arrangement rule.

On the entire surface of the conductive substrate 10 or the lower metal layer including the grown conductive nanowires 11, the dielectric layer 20 is deposited. On the deposited dielectric layer 20, the dielectric nanowires 21 are grown upward.

That is, the capacitor according to the invention includes not only the conductive nanowires 11 formed on the lower electrode 10 but also the dielectric nanowires 21 formed on the dielectric layer 20. Therefore, it is possible to expect an increase in capacitance caused by the increase in surface area.

The dielectric nanowires 21 are formed of SiO₂, Si₃N₄, Al₂O₃, ZrO₂, HfO₂, Ta₂O₅, TiO₂, SrTiO₃, BST, BaTiO₃, Pb(Zr, Ti)O₃, (Pb, La)(Zr, Ti)O₃, (Pb, La)TiO₃, SrBi₂Ta₂O₉, (Bi, La)₄Ti₃O₁₂ or a combination of at least any one of them. Preferably, the dielectric nanowires 21 have a height of 5 to 1000 nm like the conductive nanowires 11. Meanwhile, the materials of the dielectric nanowires 21, which can be applied to the invention, are not limited to the above-described materials.

Like the conductive nanowires 11, the dielectric nanowires 21 may be grown randomly on the dielectric layer 20. Alternately, the dielectric nanowires 21 may be grown on the dielectric layer 20 by using a catalyst, in accordance with a predetermined arrangement rule.

Finally, as for a positive or negative upper electrode 30 forming the uppermost portion of the capacitor, a metal layer is deposited on the entire surface of the dielectric layer 20 including the grown dielectric nanowires 21, thereby forming a capacitor having a structure shown in FIG. 3B.

Method of Manufacturing Nanowire Capacitor

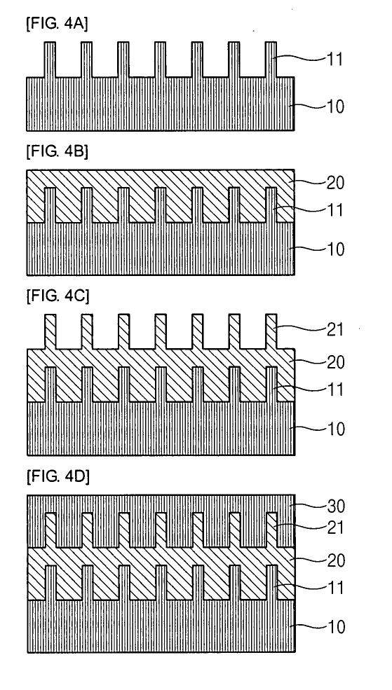

Referring to FIGS. 4A to 4D, a method of manufacturing a nanowire capacitor will be described in detail.

FIGS. 4A to 4D are sectional views showing a process for explaining a method of manufacturing a nanowire capacitor according to an embodiment of the invention.

First, as shown in FIG. 4A, a lower metal layer is formed on a substrate 10.

Meanwhile, when the substrate 10 is formed of a conductive material, the forming of the lower metal layer may be omitted.

Next, as shown in FIG. 4A, conductive nanowires 11 including metal and transparent electrodes are grown on the lower metal layer or the conductive substrate 10, thereby forming a lower electrode. The forming of the conductive nanowires 10 can be performed using well-known various methods, and the conductive nanowires 10 can be formed of a metallic material such as Fe, Co, Ni, Cu, Au, Ag or the like or a transparent electrode material such as ITO or the like.

That is, the conductive nanowires 11 can be formed using Physical Vapor Deposition (PVD), Chemical Vapor Deposition (CVD) or the like or can be grown using an electroplating method, an electroless plating method or the like such that the height of the conductive nanowires 11 ranges 5 to 1000 nm.

Meanwhile, for the growth of the conductive nanowires 11, a catalyst may be used or may be not used, depending on the growth method.

Then, a dielectric layer 20 is deposited on the entire surface of the lower metal layer or the conductive substrate 10 including the grown conductive nanowires 11 as shown in FIG. 4B.

The dielectric layer 20 is formed of SiO₂, Si₃N₄, Al₂O₃, ZrO₂, HfO₂, Ta₂O₅, TiO₂, SrTiO₃, BST, BaTiO₃, Pb(Zr, Ti)O₃, (Pb, La)(Zr, Ti)O₃, (Pb, La)TiO₃, SrBi₂Ta₂O₉, (Bi, La)₄Ti₃O₁₂ or a combination of at least any one of them. However, the material of the dielectric layer 20, which can be applied to the invention, is not limited to the above-described materials. As for a specific deposition method, the PVD or CVD can be used.

Subsequently, as shown in FIG. 4C, dielectric nanowires 21 are grown on the deposited dielectric layer 20.

The growing of the dielectric nanowires 21 can be performed using any one of the PVD, the CVD, and a sol-gel method. For the growth of the dielectric nanowires 21, a catalyst may be used or may be not used, depending on the growth method.

Finally, as shown in FIG. 4D, an upper metal layer is deposited on the entire surface of the dielectric layer 20, including the grown dielectric nanowires 21, by the PVD or CVD, thereby forming an upper electrode 30. Then, the manufacturing of the capacitor according to the invention is completed.

According to the invention, the nano structure is adopted so that the ultra-miniaturization and high integration of the capacitor can be achieved.

Although the sizes of the nanowires are reduced into several nanometers in comparison with nano particles, the nanowires can have a bulk permittivity. Further, the dielectric nanowires grown on the dielectric layer increase a contact surface area with the electrode, thereby increasing capacitance.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of manufacturing a nanowire capacitor comprising:
forming a lower metal layer on a substrate;
growing conductive nanowires on the lower metal layer, the conductive nanowires including metal and transparent electrodes;
depositing a dielectric layer on the lower metal layer including the grown conductive nanowires;
growing dielectric nanowires on the deposited dielectric layer; and
depositing an upper metal layer on the dielectric layer including the grown dielectric nanowires.

2. A method of manufacturing a nanowire capacitor comprising:
preparing a conductive substrate;
growing conductive nanowires on the conductive substrate, the conductive nanowires including metal and transparent electrodes;
depositing a dielectric layer on the conductive substrate including the grown conductive nanowires;
growing dielectric nanowires on the deposited dielectric layer; and
depositing an upper metal layer on the dielectric layer including the grown dielectric nanowires.

3. A nanowire capacitor comprising:
a substrate having a lower metal layer formed thereon;
conductive nanowires grown on the lower metal layer formed on the substrate;
a dielectric layer deposited on the lower metal layer including the grown conductive nanowires;
dielectric nanowires grown on the deposited dielectric layer; and
an upper metal layer deposited on the dielectric layer including the grown dielectric nanowires.

4. A nanowire capacitor comprising:
a conductive substrate;
conductive nanowires grown on the conductive substrate;
a dielectric layer deposited on the conductive substrate including the grown conductive nanowires;
dielectric nanowires grown on the deposited dielectric layer; and
an upper metal layer deposited on the dielectric layer including the grown dielectric nanowires.

5. The nanowire capacitor according to claim 3,
wherein the conductive nanowires are formed of any one of Fe, Co, Ni, Cu, Au, Ag, and Indium Tin Oxide (ITO).

6. The nanowire capacitor according to claim 3,
wherein the conductive nanowires and the dielectric nanowires have a height of 5 to 1000 nm.

7. The nanowire capacitor according to claim 3,
wherein the dielectric nanowires are formed of SiO₂, Si₃N₄, Al₂O₃, ZrO₂, HfO₂, Ta₂O₅, TiO₂, SrTiO₃, BST, BaTiO₃, Pb(Zr, Ti)O₃, (Pb, La)(Zr, Ti)O₃, (Pb, La)TiO₃, SrBi₂Ta₂O₉, (Bi, La)₄Ti₃O₁₂ or a combination of at least any one of the compounds.
